(19) United States
(12) Patent Application Publication
(10) Pub. No.: US 2006/0185254 A1
(43) Pub. Date: Aug. 24, 2006

(54) Titanium coated diamond containing edge material and method for manufacturing the same

(76) Inventors: Akira Hirai, Kawaguchi-shi (JP); Kimiko Sueda, Tokyo (JP)

Correspondence Address: MARGER JOHNSON & MCCOLLOM, P.C., 210 SW MORRISON STREET, SUITE 400, PORTLAND, OR, 97204, US

(21) Appl. No.: 11/060,889

(22) Filed: Feb. 18, 2005

(51) Int. Cl. B24D 18/00; C09K 3/14

(52) U.S. Cl. 51/293; 51/309; 51/307; 264/122; 419/11; 148/421

(57) ABSTRACT

The present invention provides a diamond containing edge material and a manufacturing method thereof in that the diamond containing edge material includes diamond particles thinly coated with a metallic thin film compared to the conventional Nickel (Ni) coating, and thus, the present invention provides an edge material including a plurality of diamond particles having 100 μm or less diameter at least partially coated with Titanium; and a matrix material retaining said diamond particles after processing and containing at least 50 weight percent of Titanium in relation to the total weight of said edge material.

### 1. FIELD OF THE INVENTION

The present invention relates to an edge material composed of diamond particles held in a matrix of Titanium (Ti). More particularly, the present invention relates to an edge material where diamond particles are thinly coated with Ti by a Chemical Vapor Deposition (CVD) method. The edge material containing diamond serves as a cutting edge for various types of bladed tools.

### 2. BACKGROUND OF THE INVENTION

Manufacturers of cutting tools, particularly in the field of cutlery, have made a lot of effort into making an edge material having both a sharp edge and a long-lasting sharness for repeated usage.

Manufacturers have focused on creating a material having a high hardness to maintain the sharpness of edges. Generally, hardness can be defined as a means to specify a relative resistance of a material against deformation, scratch, corrosion, or oxidization. Hardness is an important characteristic in tools that have edges since the tip end of the cutting edge of a bladed tool gradually wears down by an object to be cut or a surface on which the work is executed. For instance, cutting boards, animal bones, tough organic matters and the like wear out the edge of bladed tools. Carbon steel is a representative material having a high hardness.

Manufacturers have also exerted a lot of effort to prevent edge materials from becoming dull due to continued usage. Toughness is a measurement of a relative resistance of a material in relation to a repeated stress or wear. The ordinary metal alloy including steel alloy is a representative material having a high toughness.

Recently, ceramic compositions have been used for edge materials in wear resistance applications by its high strength, relative hardness, and chemical inertness. Typical ceramic compositions used by manufacturers are Zirconia, Alumina, a mixture of Zirconia ceramic and Titanium alloy, and the like. Ceramic compositions have a high initial hardness; however, they are fragile during use.

Through experiments, cutlery manufacturers have discovered that the hardness of cutlery tools does not have any direct relationship to the lasting sharpness. For instance, a edge of Zirconia blade having no less than 1200 HV (Vickers Hardness) is subject to scratches in use and thereby becomes inferior to a high hardness metal alloy such as SUS steel having around 700 HV. Thus, manufacturers have realized that a ceramic edge having a high hardness while low toughness under stress is not preferable to be used as a common cutlery. Thus, both metal and ceramic edges have been limited in usage due to their strengths and weaknesses, respectively, and manufacturers have sought to combine the hardness of a ceramic and the toughness of a metal alloy for the cutting edge material.

U.S. Pat. No. 6,447,569 issued in the name of Kimiko Sueta, one of the inventors of the present invention, discloses a practical cutting edge material having both high hardness and high toughness. This can be obtained by mixing Nickel (Ni) coated diamond particles with a metal alloy powder having a chemical attraction to the above particles.

However, the Ni coating is conventionally performed in an electroplating method and, thus, the Ni layer is often thickly formed to evenly and sufficiently coat the overall surface of the diamond particles. The Ni coated diamond on the market typically contains about 50 weight percent (wt %) Ni in relation to the total weight of the diamond particle. That is, the substantial amount of diamond is only 0.1 g among 0.2 g (1 carat) of Ni coated diamond. The property of high hardness of the diamond particle is difficult to be applied due to the thickly coated Ni layer. Furthermore, the weight of the blade increases due to the Ni weight. Another drawback is that if the coating layer is thick, the particle size of a diamond gets larger, causing potential removal of diamond particles during grinding. This deteriorates the cutting property of the edge material and may harm a human's health in case the cutting material is used for food cutting and noxious Ni is inserted into the food. Thus, even though Ni has an excellent chemical attraction to the Ti matrix when Ni coated diamond particles are bonded to the Ti matrix by sintering, the diamond particles should be prevented from being removed from the matrix upon impact during usage.

### SUMMARY OF THE INVENTION

The object of the present invention is to provide a diamond containing edge material that includes diamond particles thinly coated with a metallic thin film compared to the conventional Nickel (Ni) coating.

Another object of the present invention is to provide a diamond containing edge material that includes diamond particles coated with a material that is superior to the conventional Ni coating in chemical bond to the Titanium (Ti) matrix.

Another object of the present invention is to provide a diamond containing edge material that includes diamond particles coated with a harmless material to the human body compared to the conventional Ni coating. Through research, inventors of the present invention have found out that the above objects can be achieved if Ti is coated onto the diamond particles by a Chemical Vapor Deposition (CVD) method. Ti coating is superior to the Ni coating in chemical bond (sinter bonding capacity) in relation to the Ti matrix, thereby enhancing the durability of the diamond particles against impact generated during use and preventing removal of the diamond particles.

Ti can be thinly coated by the CVD; hence, the thickness of Vapor-Deposit Ti film can be formed less than or equal to 0.5 μm through the CVD method (the thickness of Ni coating is typically 200 μm or above). For instance, more than 0.19 g diamond can be contained in 0.2 g Vapor-Deposit Ti film processed products, and the high hardness feature of the diamond particles can fully be applied compared to Ni processed products. Furthermore, as the film coating can be performed thinly, the removal of particles is further prevented. The thickness of the Ti coating film is limited to 2 μm or less in this invention.

Ti is used for an artificial bone, root of a tooth and the like and nontoxic to the human body compared to Ni even if the particles are removed.

An edge material according to an embodiment of the present invention includes a plurality of diamond particles having 100 μm or less diameter at least partially coated with Ti. A matrix material retains the diamond particles after processing and contains at least 50 wt % of Ti in relation to the total weight of the edge material.

The thickness of Ti coating is preferably 2 μm or below, and the Ti coated diamond particles preferably occupy 1-15 wt % in relation to the total weight of the edge material. The matrix material includes any one selected from Vanadium Carbide (VC), Titanium Carbide (TiC) or Zirconium Carbide (ZrC), and a small amount of Silver (Ag) and Cobalt (Co) also can be included.

An edge material according to another embodiment of the present invention includes a plurality of diamond particles having 100 μm or less diameter at least partially coated with Ti in a thickness of 2 μm or less. A matrix material retains the diamond particles after processing and contains 87 wt % to 51 wt % pure Ti out of the total weight (100 wt %) of the edge material.

The matrix material preferably includes any one selected from VC, TiC, or ZrC for 10 wt % to 30 wt %, and 1 to 2 wt % Ag and 1 to 2 wt % Co may also be included. A manufacturing method of the edge material comprises a step where a plurality of diamond particles having 100 μm or less diameter is prepared. Ti is coated onto the diamond particles at 2 μm or less thickness. A matrix material containing at least 50 wt % of Ti out of the total weight of the edge material is prepared. The matrix material is processed into powder. A composition is created by mixing the diamond particles and the powder. The composition is packed in a mold. The composition is molded in a predetermined shape under a predetermined pressure. The molded composition in the predetermined shape is sintered at a predetermined temperature to form an edge material.

The matrix material can be prepared by 87 wt % to 51 wt % of pure Ti powder and 10 to 30 wt % of VC, TiC, or ZrC out of the total weight (100 wt %) of the edge material, and 1 to 2 wt % Ag and 1 to 2 wt % Co may further be included.

### BRIEF DESCRIPTION OF THE DRAWINGS

For a better understanding of the nature and objects of the present invention, reference should be made to the following detailed description with the accompanying drawings, in which:

FIG. 1 is an enlarged schematic view of an edge of a blade material according to an embodiment of the present invention;

FIG. 2 is an enlarged cross-sectional view of a cutting edge according to an embodiment of the present invention;

FIG. 3 is an enlarged cross-sectional view of a cutting edge for a paper cutter according to an embodiment of the present invention; and

FIG. 4 is an enlarged cross-sectional view of a cutting edge for a cooking knife according to another embodiment of the present invention.

### DETAILED DESCRIPTION OF THE PREFERRED EMBODIMENTS

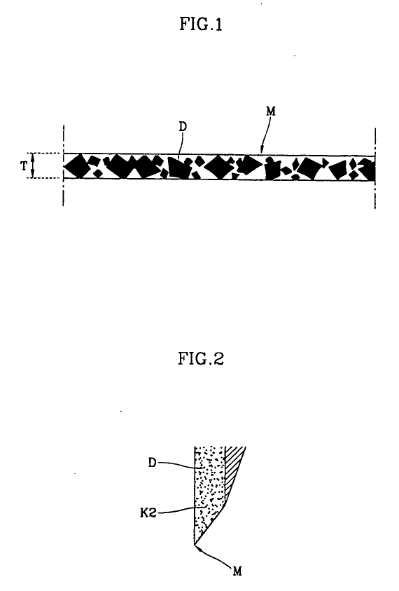

Embodiments of the present invention can be used in various kinds of bladed tools such as a cooking knife, common knife, scissors, razor, and the like. This bladed material includes a predetermined amount of diamond particles coated with Titanium (Ti). Referring to FIG. 1, the diameter of the diamond particles combined in an edge material is less than or equal to 100 μm. When the configuration of the blade is formed, diamond particles (D) are approximately arranged in a line at a narrow width and form the thickness (T) of a blade edge (M). Thus, if the diameter of the diamond particles exceeds 100 μm, the cutting property of the blade deteriorates.

The mixture ratio of the diamond particles included in the edge material is varied depending on the object cut by the edge of the cutlery, however, preferably in the range of 1-15 weight percent (wt %) in relation to the total weight of the edge material. If the weight of the diamond particle is less than 1 wt %, the cutting property is insufficient. If the weight of the diamond particle is above 15 wt %, the holding power of matrix i.e., pure Titanium or Titanium alloy, against the diamond particle is insufficient.

The edge material includes pure Titanium or Titanium alloy containing more than 50 wt % of pure Ti as the matrix of the diamond particle. The mixture and detailed examples of the edge material are described below. In the examples, Vanadium Carbide (VC) can be substituted at the identical wt % by Titanium Carbide (TiC) powder or Zirconium Carbide (ZrC) powder. The Ti matrix can add strength and flexibility to the high hardness diamond particle. Thus, once the edge of the blade is formed by mixing the matrix and diamond particles, chipping of the edge can effectively be prevented during use.

The diameter of the diamond particles is 100 μm or less, and the thickness of the Ti coating on the diamond particles is preferably 2 μm or less. Ti can be coated as thinly as 2 μm or less by using the Chemical Vapor Deposition (CVD) method. As the conventional Ni coating uses the electroplating method, the coating thickness takes up to 200 μm for an even coating. In the embodiment of the present invention, however, the Ti coating can be thinly formed within 2 μm by using the CVD. Thus, the high hardness of the diamond particles can optimally be used by thinning the Ti coating. Furthermore, the bonding capacity (chemical attraction) of the diamond particles with the Ti matrix is improved, thereby greatly minimizing the chipping on the edge material in use.

### MIXTURE EXAMPLE

edge material (100 wt %)

Ti matrix (99-85 wt %)
pure Ti 87-51 wt %
VC 10-30 wt %
Silver (Ag) 1-2 wt %
Cobalt (Co) 1-2 wt %

Ti coated diamond particle powder (1-15 wt %)

### DETAILED EXAMPLE

The gross weight of the below powders should be adjusted in the relevant weight ranges to form 100 wt %.

Pure Ti or Ti alloy powder (84-50 g)

VC powder (15-40 g)

Ti coated diamond particle powder (1-10 g)

The composition created according to the above mixture example is packed in a mold and compressed. Next, the composition is sintered in the vacuum or inert gas furnace and then the sintered material is formed in a shape for a desired edge material. The above material is typically sintered at 1400° C. or below to prevent the deformation of diamond or matrix alloy. However, the temperature value may be changed according to the furnace structure or the like.

The method for manufacturing the edge material according to the embodiment of the present invention will now be described.

The composition of the above detailed example is packed in a mold having a desired shape. After compression, the composition is sintered either in a vacuum or inert gas furnace. The sintering temperature is preferably 1400° C. or below to prevent the deformation of the diamond particles or matrix alloy; however, the degree of the temperature value may be changed corresponding to the furnace structure or the like.

The sintered composition is taken out from the mold and undergoes an edge shaping process. After processing, diamond particles with 100 μm diameter are substantially arranged in one line at the edge of the above composition. The diamond particles fixed in one line functions as the edge of the blade and, thus, a very sharp edge is formed. Particularly, as the Ti coating can be formed below 2 μm, a sharper edge can be obtained in the embodiment of the present invention than the conventional Ni coating having 200 μm or more thickness. Further, the sintered Ti or Ti alloy can form a retention matrix between diamond particles, thus obtaining both relative flexibility and toughness of the blade and preventing the chipping of the edge thereof.

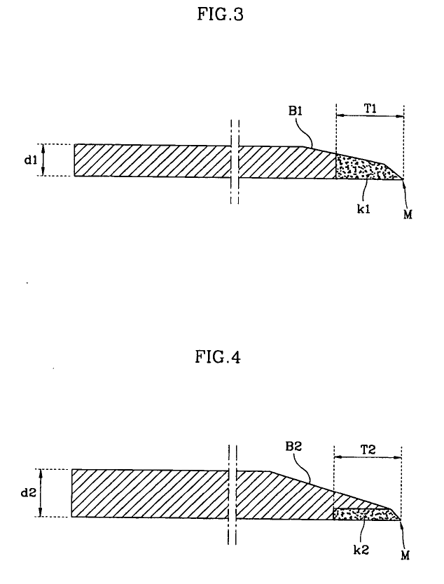

FIG. 3 is a cross-sectional view of a paper cutter according to an embodiment of the present invention. The height (t1) of an edge material portion (K1) containing Ti coated diamond is 10 mm in relation to an edge plate portion (B1) having 1.5 mm thickness (d1). The edge plate portion (B1) is composed of pure Ti or Ti alloy, and molded and sintered simultaneously with the edge material portion (K1). The angle of the blade edge (M) is formed to be about 15° in relation to the plane surface of the drawing.

FIG. 4 illustrates a cross-sectional view of a thick cooking knife according to another embodiment of the present invention. FIG. 2 is an enlarged view of the front tip of FIG. 4. The height (t2) of an edge material portion (K2) is 10 mm in relation to an edge plate portion (B2) having a thickness (d2) of 3 mm. The thickness of the edge material portion (K2) is as thin as 0.3 mm. When the shape of the blade edge (M) is formed, the cross-sectional view of the edge material portion (K2) is approximately a trapezoid as shown in the drawing. The inclination angle of the tapered surface for the edge plate portion (B2) is about 6° in relation to the plane surface of the drawing, and the blade edge (M) is 15°, which is identical to the example of FIG. 3. In order to produce a cooking knife as illustrated in the drawing, the edge material portion (K2) having a rectangular cross-section of 10 mm′ 0.3 mm is packed in a mold with the composition of the edge plate portion (B2) (i.e., pure Ti powder or Ti alloy powder) for molding and sintering and then forming the shape of the blade edge.

The edge material portions (K1 and K2) are manufactured according to their intended usage. For instance, the edge material portion (K1) of a paper cutter will be much longer than the edge material portion (K2) of a cooking knife, and when cutting a thick bundle of paper, the edge of the blade will receive more pressure and wear. Thus, the edge material portion (K1) is thicker than the edge material portion (K2). As a part of the cooking knife, the edge material portion (K2) should have a strong and keen edge in accordance with customers' desire and be thinly formed to reduce the material cost.

The compositions of the edge material portions (K1 and K2) can be used as the compositions of the entire blade material of FIGS. 3 and 4 by expending (not shown) the compositions up to the edge plate portions (B1 and B2).

The edge material containing Ti coated diamond according to the embodiment of the present invention can be coated by a thinner film compared to the conventional edge material containing Ni coated diamond particles, thereby enabling to apply the unique characteristic of a diamond. The present invention is also superior to the conventional Ni coating in the chemical bond capacity to the Ti matrix, thereby effectively preventing the chipping of the edge during use. The edge material containing Ti coated diamond in the embodiment of the present invention further uses at the edge portion thereof Ti incorporating Ag having an antibacterial property, thereby being harmless to the human body compared to the conventional Ni coated diamond containing edge material.

What is claimed is:

1. An edge material including a plurality of diamond particles having 100 μm or less diameter at least partially coated with Titanium; and
a matrix material retaining said diamond particles after processing and containing at least 50 weight percent of Titanium in relation to the total weight of said edge material.

2. The edge material as defined in claim 1, wherein the thickness of said Titanium coating is 2 μm or less.

3. The edge material as defined in claim 1, wherein said Titanium coated diamond particles take up about 1-15 weight percent in relation to the total weight of said edge material.

4. The edge material as defined in claim 1, wherein said matrix material includes any one selected from Vanadium Carbide, Titanium Carbide or Zirconium Carbide.

5. The edge material as defined in claim 1, wherein said matrix material includes Silver.

6. The edge material as defined in claim 1, wherein said matrix material includes Cobalt.

7. The edge material as defined in claim 1, wherein said Titanium coating is performed by a Chemical Vapor Deposition method.

8. An edge material including a plurality of diamond particles having 100 μm or less diameter at least partially coated with Titanium at 2 μm or less thickness; and
a matrix material retaining said diamond particles after processing and containing 87 weight percent to 51 weight percent pure Titanium out of the total weight (100 weight percent) of said edge material.

9. The edge material as defined in claim 8, wherein said matrix material includes any one selected from Vanadium Carbide, Titanium Carbide or Zirconium Carbide for 10 to 30 weight percent.

10. The edge material as defined in claim 9, wherein said matrix material includes 1 to 2 weight percent of Silver and 1 to 2 weight percent of Cobalt.

11. The edge material as defined in claim 8, wherein said Titanium coating is performed by a Chemical Vapor Deposition method.

12. A manufacturing method of an edge material, comprising the steps of:
preparing a plurality of diamond particles having 100 μm or less diameter;
coating Titanium on said diamond particles at 2 μm or less thickness;
preparing a matrix material containing at least 50 weight percent Titanium in the total weight of said edge material;
processing said matrix material into a powder;
creating a composition by mixing said diamond particles with said powder;
packing said composition in a mold;
molding said composition in a predetermined shape under a predetermined pressure; and
forming said molded and shaped composition into an edge material by sintering at a predetermined temperature.

13. The method as defined in claim 12, wherein said matrix material includes 87 weight percent to 51 weight percent of pure Titanium powder and 10 to 30 weight percent of Vanadium Carbide, Titanium Carbide or Zirconium Carbide out of the total weight (100 weight percent) of the edge material.

14. The method as defined in claim 13, wherein said matrix material further includes 1 to 2 weight percent Silver and 1 to 2 weight percent Cobalt.

15. The method as defined in claim 12, wherein said Titanium coating is performed by a Chemical Vapor Deposition method.
